(19) United States
(12) Patent Application Publication
(10) Pub. No.: US 2014/0001393 A1
(43) Pub. Date: Jan. 2, 2014

(54) DROP-IN CONTAINMENT SLEEVE

(71) Applicant: Patricia Selcher, Albuquerque, NM (US)

(72) Inventor: Patricia Selcher, Albuquerque, NM (US)

(21) Appl. No.: 13/783,270

(22) Filed: Mar. 2, 2013

Related U.S. Application Data
(60) Provisional application No. 61/666,848, filed on Jun. 30, 2012.

(51) Int. Cl. F16K 25/00

(52) U.S. Cl. CPC F16K 25/00
USPC 251/359

(57) ABSTRACT

The drop-in containment sleeve is an apparatus designed to work in conjunction with a flow control device for preventing a dense liquid (such as diesel fuel) from being dispensed into a storage tank that contains a less dense liquid, such as gasoline fuel, (and vice versa) by allowing the device to seal against an inside lip of the sleeve, thereby fully- or partially-containing the fluid that activated the flow control device. In petroleum fuel applications, the containment sleeve can replace the inlet collar of the filler tube.

### CROSS-REFERENCE TO RELATED APPLICATIONS

This application claims the benefit of U.S. Provisional Application No. 61/666,848, Drop-In Containment Sleeve with Internal Sealing Lip, filed Jun. 30, 2012, incorporated herein by reference.

### FEDERALLY SPONSORED RESEARCH

Not applicable.

### BACKGROUND OF THE INVENTION

The technical field of the invention relates to flow control devices, valves, piping, tubing, adaptors, collars, and transition pieces used for the transportation, delivery, unloading, storage, and pumping of liquids; primarily petroleum fuel (gasoline and diesel fuel) to underground storage tanks.

Underground storage tanks are used for storing liquids, primarily petroleum fuel (e.g., gasoline and diesel fuel) at gas stations, truck stops, pipeline terminals, and refineries. Although the tanks are marked or color-coded to alert the delivery person as to what type of fuel is contained within the tanks, mistakes can happen; with the wrong type of fuel being unloaded into the wrong tank. When this happens, the intermixed fuel (gasoline+diesel, or diesel gasoline) cannot be used for any type of vehicle.

In January of 2010, a patent was granted to E. Zsigmond of Albuquerque, N. Mex., for “Transmix Prevention Lock” (U.S. Pat. No. 7,644,723, which is incorporated herein by reference). Zsigmond's patent (“the '723 patent”) describes a compact, mechanical flow control device, the Transmix Prevention Lock (TPL), which in a typical installation is placed inside of a fuel filler tube near the top (where a fuel transfer hose would be attached to from a supply truck) within a standpipe that is attached to a petroleum storage vessel. When fuel is unloaded/transferred into the fuel filler tube, some of the fuel enters the TPL. When the correct fuel is used, the stopper plates (116) remain latched in their “open” configuration, which allows the fuel to pass thru the device and down into the storage tank below. But, if the wrong kind of fuel is unloaded (e.g., diesel, instead of gasoline), the TPL “activates” and unlatches/releases the pair of stopper plates (116), which snap down into a “closed” or “activated” configuration that blocks much of the fuel flowing down the filler tube. This is illustrated in FIGS. 1 and 2 of the '723 patent.

One of the problems with the TPL device described in the '723 patent relates to the radial clearance (gap) that exists between the outer edge of the stopper plates (116) and the inner surface of the filler tube (118). A positive, non-zero, radial clearance gap is required so that the stopper plates can rotate freely without hitting or hanging up on the inner surface of the filler tube (118). This relates to the second problem with the TPL device. In normal operation, when the TPL device is activated by the wrong kind of fuel, the TPL is closed (FIG. 2 of the '723 patent), and the flow of fuel is blocked. This leaves a certain volume of fuel that is trapped and remains inside of the filler tube, above the level of the closed stopper plates. The problem, however, is that this certain volume of undesired fuel leaks down through the clearance gap and into the storage tank. Eventually, all of the initially trapped intermixed fuel slowly leaks into the tank, which is an undesirable situation.

### BRIEF SUMMARY OF THE INVENTION

The drop-in containment sleeve of the present invention is designed to work in conjunction with a flow control method and apparatus for preventing a dense liquid (such as diesel fuel) from being dispensed into a storage tank that contains a less dense liquid, such as gasoline fuel (and vice versa), by allowing the apparatus to close and seal tightly via a resilient and compressible seal (e.., an O-ring seal) against an inside lip of the sleeve (i.e., an inwardly-facing bottom flange), thereby fully containing or partially containing the fluid within the sleeve.

In petroleum fuel applications, the containment sleeve can replace the inlet collar of a fuel filler tube. The invention can use a longer tube (approximately 8″-12″ long) to contain excess fluid. An example of a drop-in containment sleeve comprises: a long, cylindrical tube with an open central bore; an open top end; an open bottom end; 2-4 bolt holes passing through the sleeve's sidewall, dispersed around the circumference near the top; an outwardly-extending top flange; and an inwardly-extending bottom flange (sealing lip) for holding an O-ring seal.

### BRIEF DESCRIPTION OF THE DRAWINGS

The accompanying drawings, which are incorporated in and form part of the specification, illustrate various examples of the present invention and, together with the detailed description, serve to explain the principles of the invention.

FIGS. 1A-1E show cross-sectional, elevation views of the drop-in containment sleeve according to the present invention, with and without a TPL type flow control device.

FIGS. 2A-2C show cross-sectional, elevation views of the drop-in containment sleeve according to the present invention as disposed within a standpipe.

FIGS. 3A-3B show cross-sectional, elevation views of the drop-in containment sleeve according to the present invention as disposed with a filler tube within a standpipe.

FIGS. 4A-48 show alternate embodiments of the drop-in containment sleeve according to the present invention in cross-sectional, elevation views.

FIGS. 5A-5B show alternate embodiments of the drop-in containment sleeve according to the present invention in cross-sectional, elevation views.

FIGS. 6A-6B show alternate embodiments of the drop-in containment sleeve according to the present invention in cross-sectional, elevation views with relative dimensions noted.

FIG. 7 shows an isometric view of a seamless drop-in containment sleeve according to the present invention.

FIG. 8 shows a depiction of a curled hem edge on the bottom flange in one embodiment.

FIG. 9 shows one embodiment of an O-ring seal configuration between a drop-in containment sleeve and the stopper plates of a TPL type flow control device.

FIG. 10 shows one embodiment of an O-ring seal configuration between a drop-in containment sleeve and the stopper plates of a TPL type flow control device.

FIG. 11 shows one embodiment of a sealing configuration between the bottom flange in the drop-in containment sleeve of the present invention and a stopper plate of a TPL type flow control device.

FIG. 12 shows one embodiment of a sealing configuration between the bottom flange in the drop-in containment sleeve of the present invention and a stopper plate of a TPL type flow control device.

FIG. 13 shows one embodiment of a sealing configuration between the bottom flange in the drop-in containment sleeve of the present invention and a stopper plate of a TPL type flow control device,

FIG. 14 shows one embodiment of a sealing configuration between the bottom flange in the drop-in containment sleeve of the present invention and a stopper plate of a TPL type flow control device.

FIG. 15 shows one embodiment of a sealing configuration between the bottom flange in the drop-in containment sleeve of the present invention and a stopper plate of a TPL type flow control device.

FIG. 16 shows one embodiment of a sealing configuration between the bottom flange in the drop-in containment sleeve of the present invention and a stopper plate of a TPL type flow control device.

FIG. 17 shows a black and white photograph of a prototype Containment Sleeve made according to FIG. 4A (Version 2).

### DETAILED DESCRIPTION OF THE INVENTION

The drop-in containment sleeves of the present invention are devices designed to work in conjunction with a Transmix Prevention Lock (TPL) type flow control device, such as the “Safe Lock” device sold by TransMixSafeLock of Albuquerque, New Mexico. In one embodiment, where the TPL type flow control device is used to prevent unwanted introduction of a diesel fuel into a gasoline fuel storage vessel (or alternatively, to prevent unwanted introduction of a gasoline fuel into a diesel fuel storage vessel), the drop-in containment sleeve of the present invention is emplaced in the standpipe of the fuel storage vessel, where the standpipe is used to transmit the incoming fuel into the storage vessel. The TPL type flow control device is inserted or emplaced with the containment sleeve of the present invention inside of the standpipe. A standpipe in the present invention is any pipe, generally rigid, used for transmitting a fluid inserted into one end into some other vessel. In one embodiment, the standpipe provides for introduction of a petroleum liquid into a petroleum containment vessel. The containment sleeve is dimensionally compatible with both the TPL device and the standpipe. When a TPL type flow control device is disposed or emplaced within the drop-in containment sleeve of the present invention, a fluid flow protection system results which is capable of preventing unwanted or incompatible fluids from being transmitted through the TPL flow control device into a storage vessel.

The sleeves are typically made of a metal alloy (such as aluminum alloy, steel, brass), but can also be made of a fiber-reinforced plastic (FRP), or other composite material, such as a carbon-fiber reinforced composite. Any material can be used that has sufficient mechanical strength to support the TPL type flow control device and that is also relatively inert chemically with the fluid introduced into the device.

A Drop-in Containment Sleeve (“Sleeve”), according to the present invention, comprises an open-ended hollow cylindrical tube, an outwardly-extending top flange; and an inwardly-extending bottom flange (“sealing lip”) configured for allowing a liquid-tight seal to be made between the bottom flange and a TPL flow control device. The open-ended hollow cylindrical tube comprises a tube with an open central bore; an open top end; an open bottom end; and a sidewall. Typically, the TPL device has a pair of stopper plates at the bottom of the device that deploy to block flow of undesired fluid. In one embodiment, the liquid-tight seal in the present invention is made between the bottom flange of the sleeve and these stopper plates, typically using an O-ring seal or other similar sealing device.

Optionally, one or more O-ring seals can be used with the Sleeve other than at the bottom of the sleeve to provide for the liquid-tight seal between the bottom flange and the TPL. For example, additional O-rings can be located along the outer sidewall of the sleeve between the top end and bottom end and along the extending top flange to prevent liquid flow between the sleeve and the standpipe. The O-ring seals can be made of an elastomeric material that is resistant to petroleum vapors, e.g., nitrite rubber (also known as Buna-N or NBR), which is a synthetic rubber copolymer of acrylonitrile (ACN) and butadiene.

Typically, the sleeves are fabricated with a plurality of bolt holes (for example, 2, 3, or 4 bolt holes) drilled or punched through the sidewall, and which are spaced apart circumferentially in a uniform manner. The bolt holes can provide structural support to the sleeve of the present invention when the sleeve is placed in a standpipe of a liquid storage vessel. Alternatively, the bolt holes may be pre-drilled or drilled in the field to ensure the hole placement in the Sleeve matches the hole placement of the inlet collar being replaced.

In any embodiment of a Sleeve that uses one or more bolts to attach or hold a Sleeve to another structure, a small O-ring seal (or equivalent) can optionally be used underneath each bolt head to provide a liquid- and vapor-tight seal around each of the bolt holes.

The drop-in containment sleeves of the present invention can be installed on and retrofitted to existing petroleum storage tanks. One way, for example, is to replace the existing inlet collar with a drop-in containment sleeve.

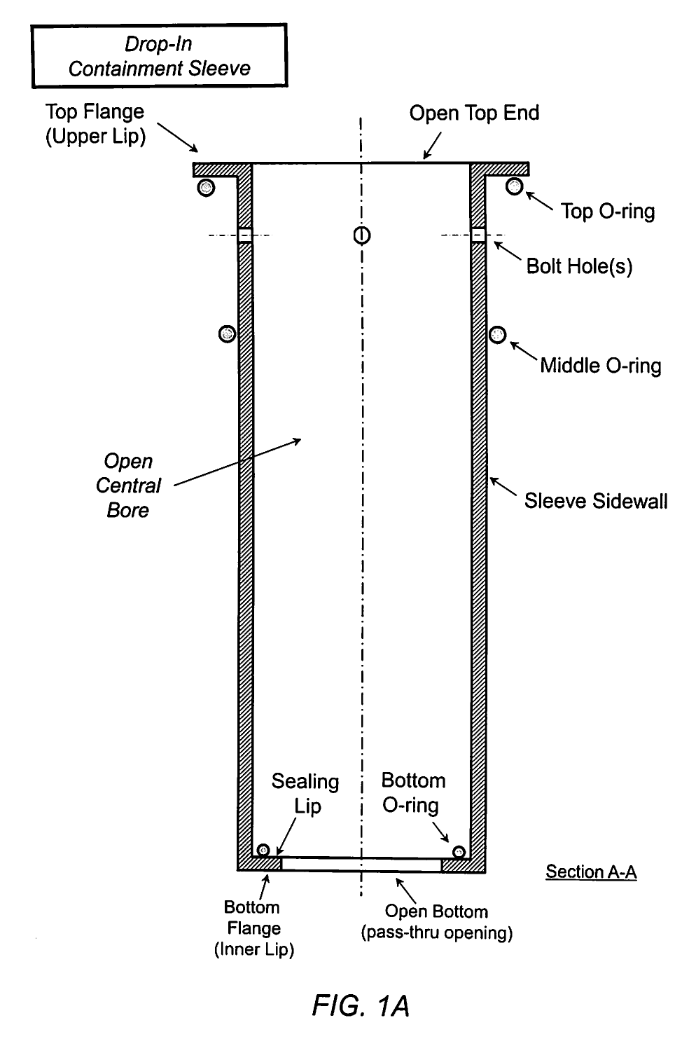

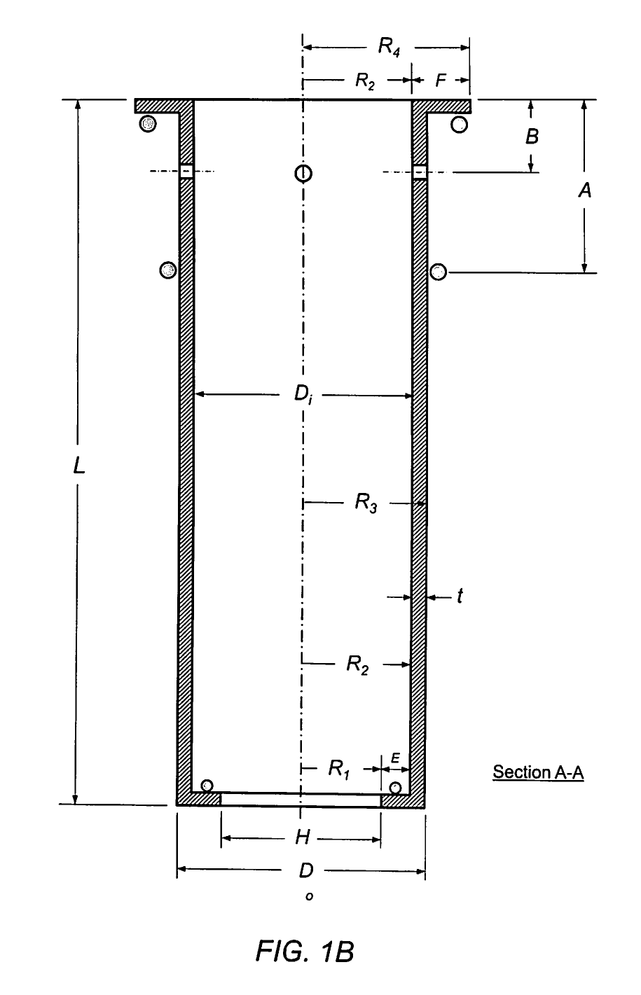

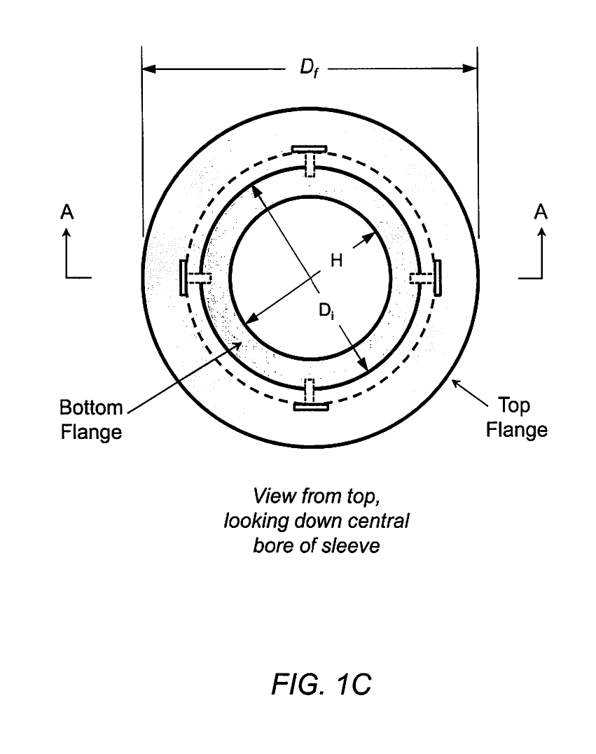

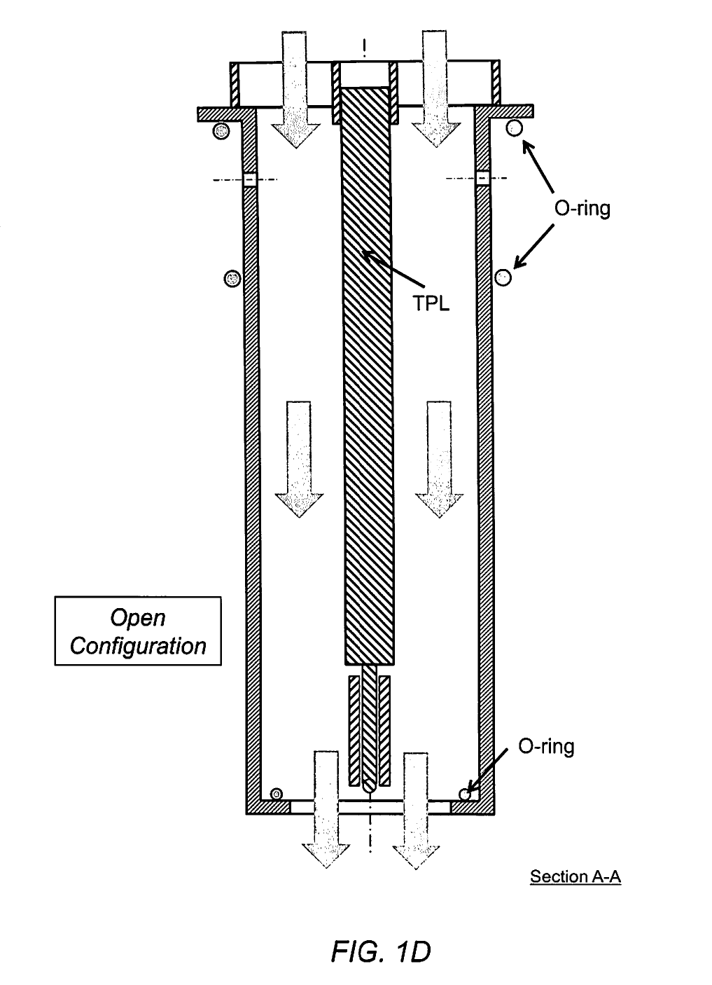

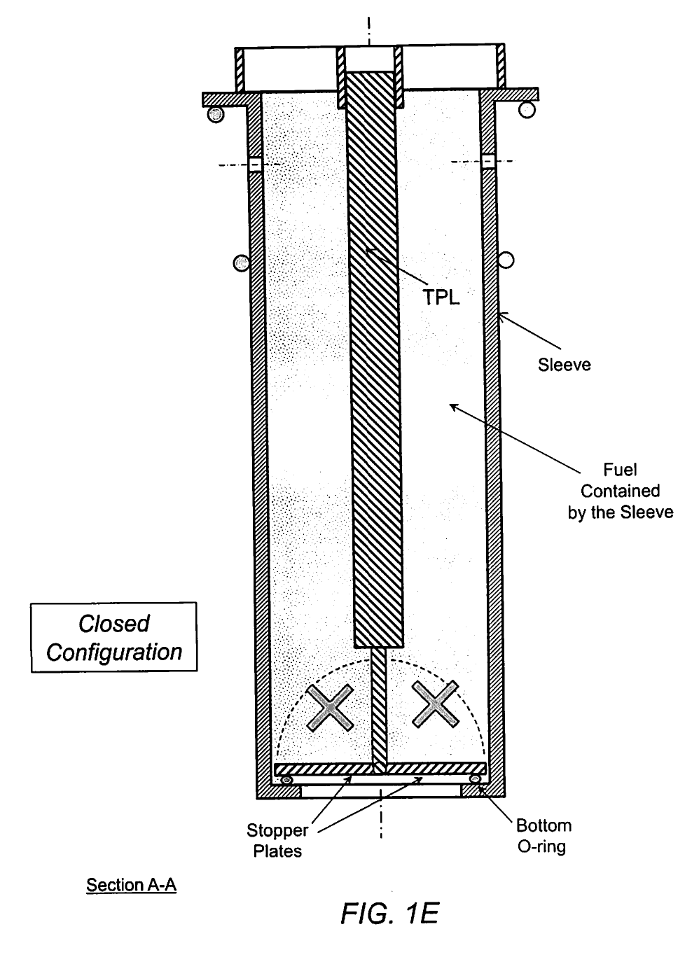

FIG. 1A shows a cross-section, elevation view of one embodiment of a Drop-in Containment Sleeve (“Sleeve”), according to the present invention. The Sleeve comprises a long, cylindrical tube with an open central bore; an open top end; an open bottom end; a straight sidewall; 4 bolt holes through the sidewall, near the top end; an outwardly-extending top flange; and an inwardly-extending bottom flange (sealing lip) for holding an O-ring seal. Additionally, a set of three (or more) O-ring seals are provided with the Sleeve: a bottom O-ring, a middle O-ring, and a top O-ring. The O-rings can be made of an elastomeric material that is resistant to petroleum vapors, e.g., nitrile rubber (also known as Buna-N or NBR), which is a synthetic rubber copolymer of acrylonitrile (ACN) and butadiene.

FIG. 1B shows labeled dimensions of the Sleeve of FIG. 1A. In a petroleum fuel application, the following ranges of dimensions can be used. The length, L, can range from 8-12″, with an average of about 10″. The inside diameter, D and outside diameter, D_{0,} can range from 2-5″, with a nominal value of 3.5″. The wall thickness, t, can range from 0.020-0.125″, with a nominal value of 0.050″. The inner diameter, H, of the bottom opening can be about 3″. The radial width, E, of the sealing lip of the bottom flange, can range from 0.2-0.5′, with a nominal value of 0.25″. To properly support the bottom O-ring seal, the width, E, of the sealing lip should not be less than 0.2″. The first inner radius, R₁, of the bottom opening can range from 1-2″, with a nominal value of 1.51″. The second inner radius, R₂, of the inner sidewall can range from 1-2″, with a nominal value of 1.76″. The ratio of the first and second inner radii, R₁/R₂≧0.8. In other words, R₁ must be at least 80% of R₂. The inner radius, R₃, of the outer sidewall can range from 1-2″, with a nominal value of 1.81″. The outer radius, R₄, of the top flange can range from 1.5-3″, with a nominal value of 2.25″. The radial width, F, of the top flange can range from 0.375-0.75″, with a nominal value of 0.5″. The distance, A, can range from 2-5″, with a nominal value of 4″. The distance, B, can range from 0.5-2″, with a nominal value of 1″.

FIG. 1C shows a view from the top looking down into the central bore of the Sleeve of FIG. 1A. The outer diameter, D_{f}, of the top flange can range from 3-6″, with a nominal value of 4.5″. The bottom flange, with an inner diameter=H, is visible looking down the central bore. In this figure, the Bottom O-ring is not illustrated.

FIG. 1D shows a cross-section, elevation view of an example of a Drop-in Containment Sleeve (“Sleeve”), with a Transmix Prevention Lock (TPL) installed in the Sleeve of FIG. 1A, according to the present invention. The TPL is in the open configuration, with the pair of stopper plates latched up. This allows fuel to flow freely through the Sleeve from top to bottom, with the flow direction depicted by the flow arrows. Potential O-ring locations are also depicted.

FIG. 1E shows a cross-section, elevation view of an example of a Drop-in Containment Sleeve (“Sleeve”), with a Transmix Prevention Lock (TPL) installed in the Sleeve of FIG. 1A, according to the present invention. The TPL is in the closed (“activated”) configuration, with the pair of stopper plates released and folded down. The stopper plates make a liquid-tight seal with the bottom O-ring. The sleeve thereby contains the undesired fuel that is blocked by the activated TPL.

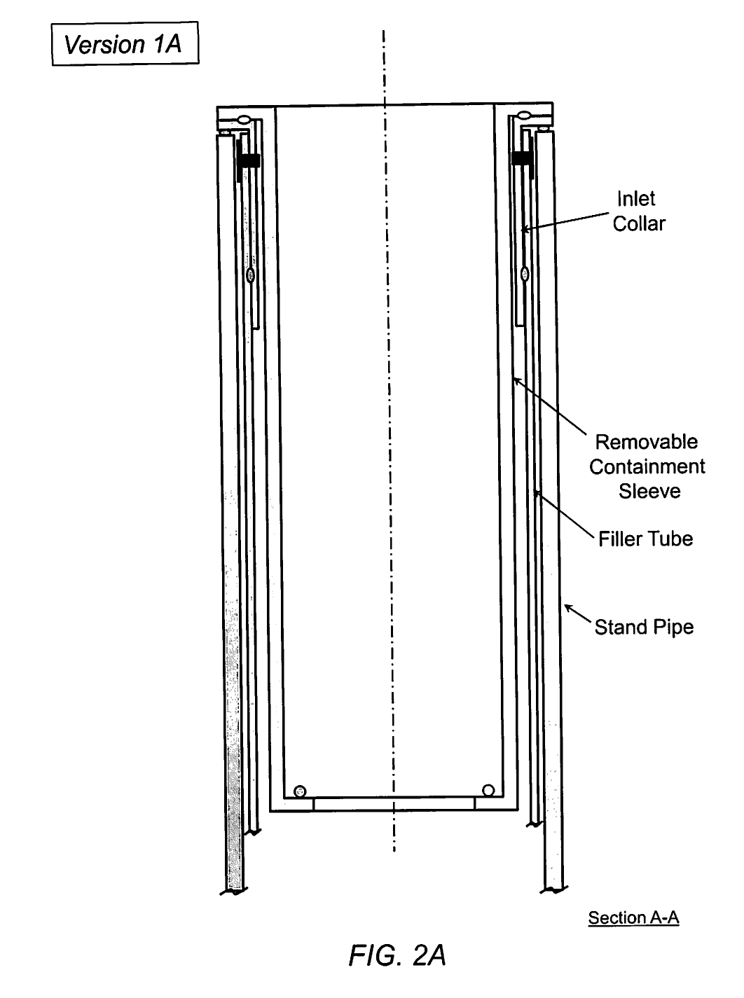

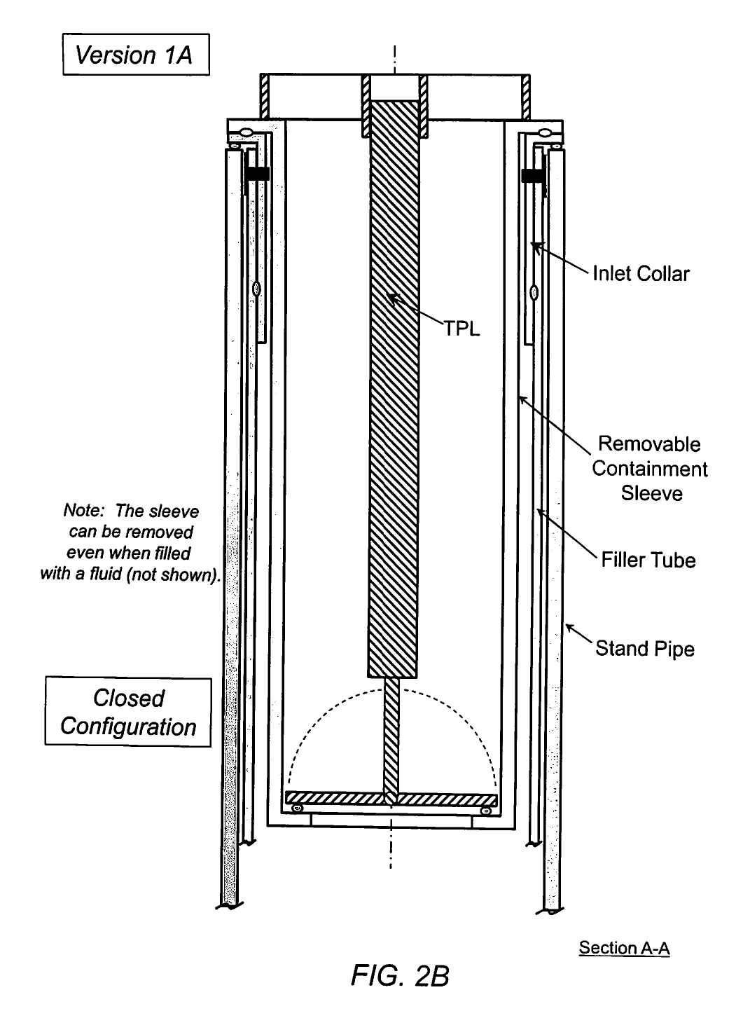

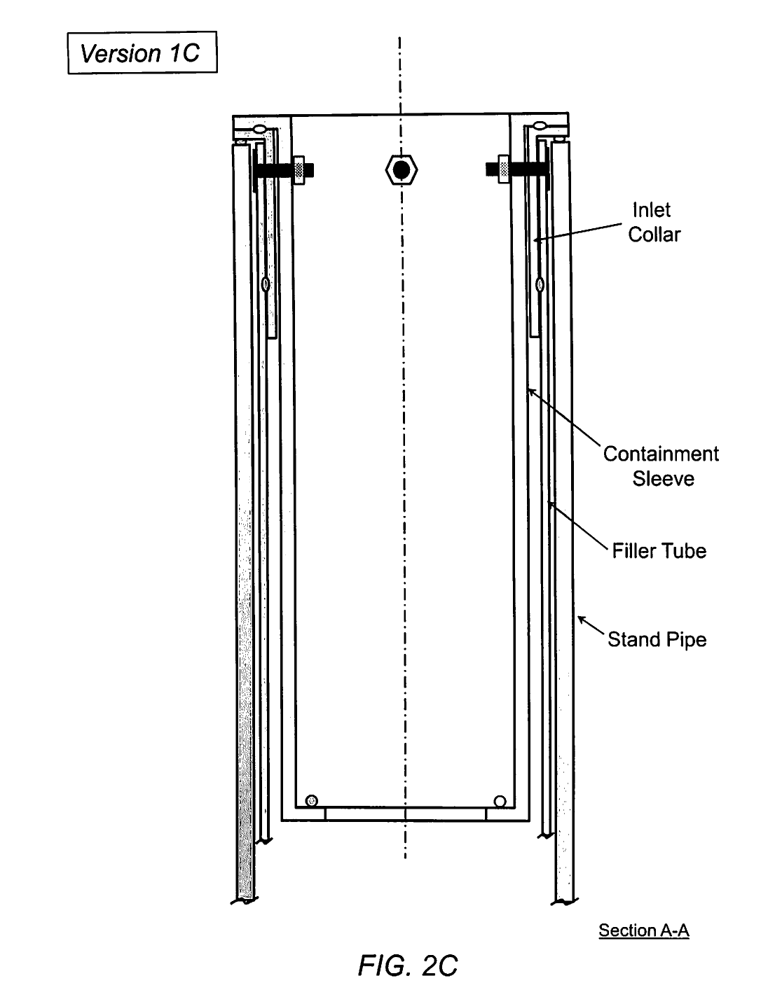

FIG. 2A shows a cross-section, elevation view of another example of a Drop-in Containment Sleeve (“Sleeve”), according to the present invention. FIG. 2A shows four concentric (nested) structures. In this embodiment (Version 1A) the containment sleeve (removable) is installed inside of an Inlet Collar contained within a standpipe, with the top flange of the Sleeve resting on a top flange of the Inlet Collar. An optional O-ring seal (yellow) can be used in-between the pair of top flanges. The top flange of the Inlet Collar, which is located inside of a Filler Tube, rests on the top end of a Stand Pipe, with the top O-ring seal in-between (in red). The Filler Tube is bolted to, and hangs from, the Inlet Collar at 4 positions circumferentially, using custom bolts that have very thin heads. The middle O-ring seal (red) is disposed in-between the sidewall of the Inlet Collar and the Filler Tube. Note that the containment sleeve is removable in this example, because the sleeve is not bolted to any other structure (there are no bolt holes in the sleeve).

FIG. 2B shows the Sleeve of FIG. 2A, with a Transmix Prevention Lock (TPL) installed in the Sleeve. The TPL is in the closed (“activated”) configuration, with the pair of stopper plates released and folded down. The stopper plates make a tight seal with the bottom O-ring. The Sleeve can contain fuel that is stopped by the closed TPL. Note: that the containment sleeve in this configuration can be removed, even when filled with a fluid (i.e., fuel), because it is not bolted to any other structure.

FIG. 2C shows the same Sleeve as FIG. 2A, except that the (4) bolts extend all the way through the Sleeve in this example. Hence, in FIG. 2C, the Sleeve is not removable because it bolted to the Inlet Collar and the Filler Tube.

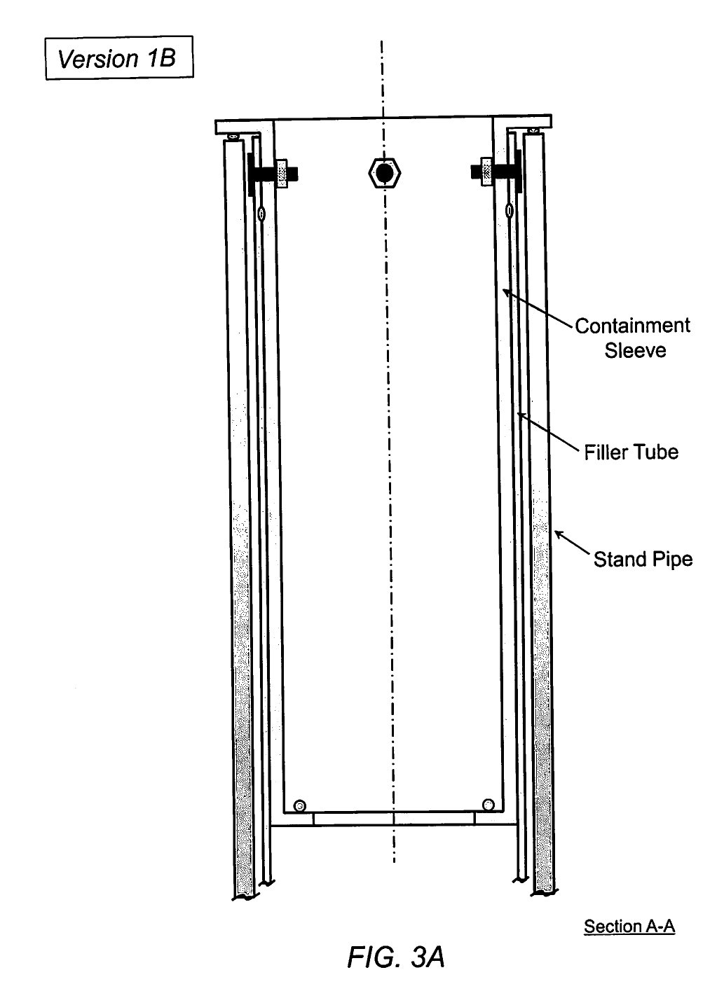

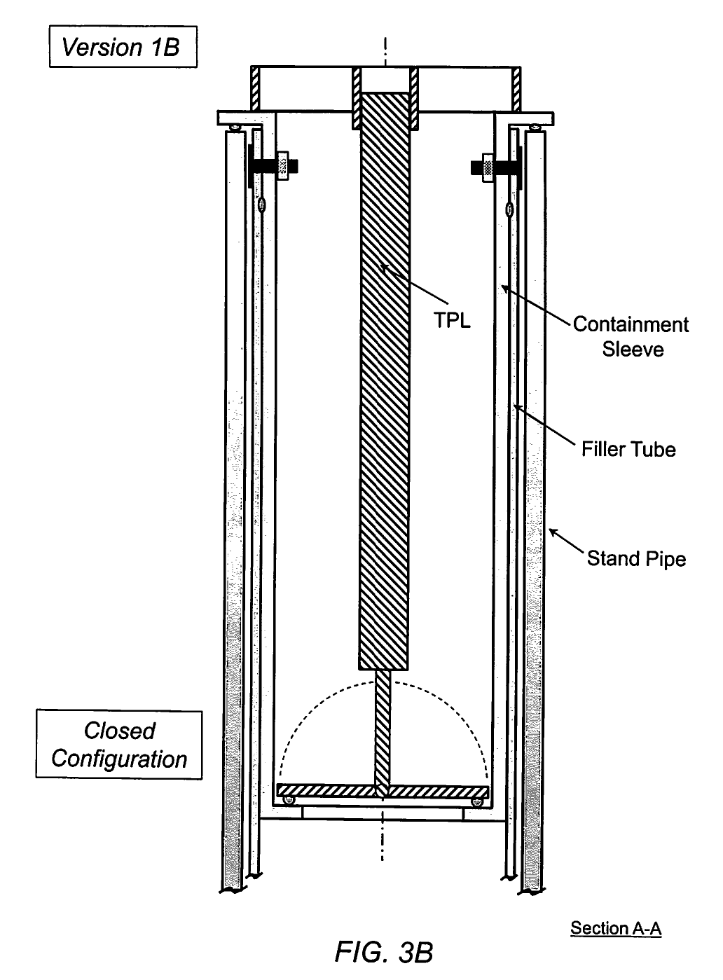

FIG. 3A shows a cross-section, elevation view of another example of a Drop-in Containment Sleeve (“Sleeve”), according to the present invention. FIG. 3A shows three concentric (nested) structures. In this embodiment (Version 1B) the containment Sleeve is installed inside of a Filler Tube, with the top flange of the Sleeve resting on the top end of a Stand Pipe (or alternatively, Standpipe), and with the top O-ring seal (in red) disposed in-between. The Filler Tube is bolted to, and hangs from, the Containment Sleeve at 4 positions circumferentially, using special bolts that have very thin heads. Since the Sleeve bolts directly to the Filler Tube, the Sleeve replaces the Inlet Collar. The middle O-ring seal (red) is disposed in-between the sidewall of the Containment Sleeve and the Filler Tube.

FIG. 3B shows the Sleeve of FIG. 3A, with a Transmix Prevention Lock (TPL) installed in the Sleeve, The TPL is in the closed (“activated”) configuration, with the pair of stopper plates released and folded down. The stopper plates make a tight seal with the bottom O-ring. The Sleeve can contain fuel that is blocked by the closed TPL.

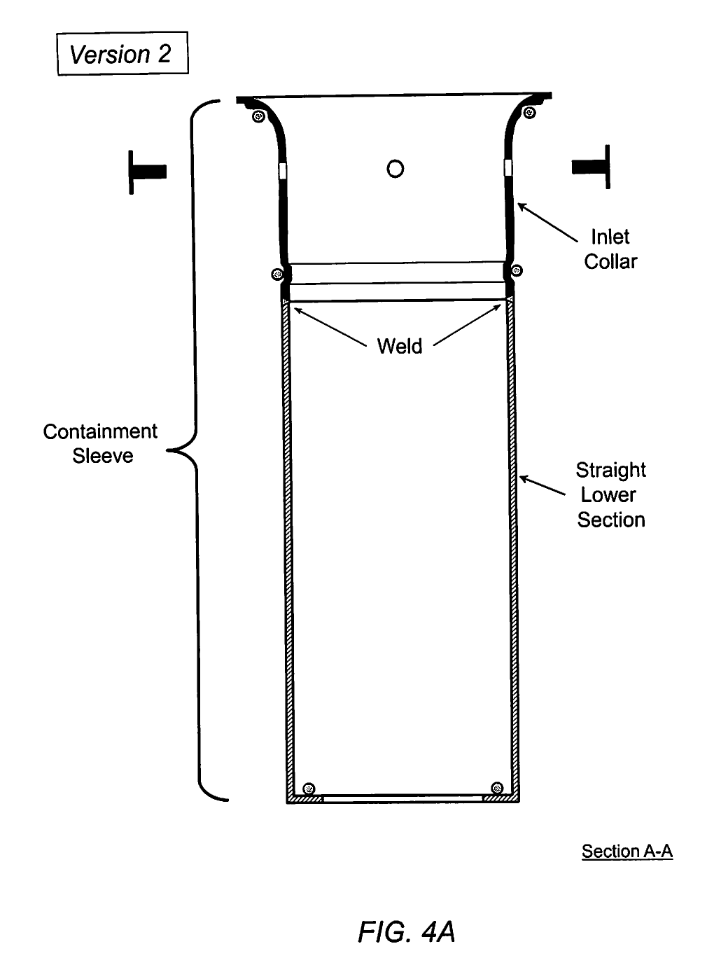

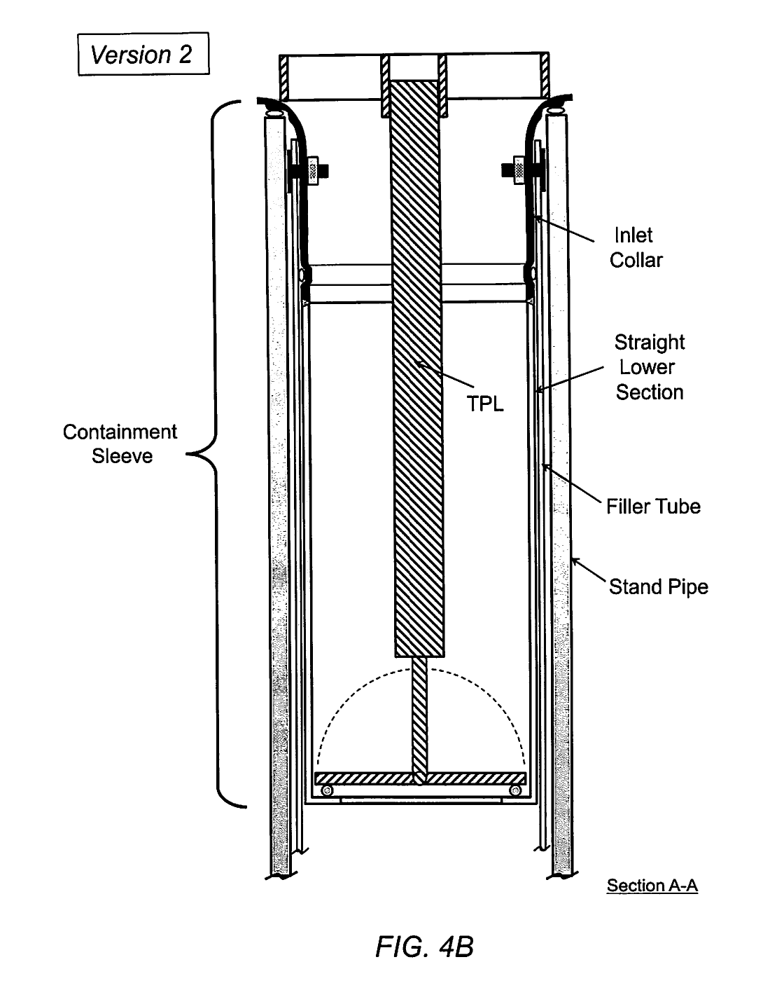

FIG. 4A shows a cross-section, elevation view of another example of a Drop-in Containment Sleeve (“Sleeve”), according to the present invention. In this embodiment (Version 2) the Containment Sleeve comprises two parts that are joined together (e.g., by a welded seam) to make a single piece. The upper part is a commercially-available Inlet Collar, with a fluted/curved top flange with a circumferential flat for holding/seating the top O-ring seal; multiple bolt holes; and a dimpled, circumferential groove for holding the middle O-ring seal. The lower part is a straight section of tubing, with the inwardly-facing bottom flange (bottom sealing lip) formed on the bottom end.

FIG. 4B shows the Sleeve of FIG. 4A, with a Transmix Prevention Lock (TPL) installed in the Sleeve. The TPL is in the closed (“activated”) configuration, with the pair of stopper plates released and folded down. The stopper plates make a tight seal with the bottom O-ring. The Sleeve can contain fuel that is stopped by the closed TPL. In this embodiment (Version 2) the Containment Sleeve is installed inside of a Filler Tube, with the top flange of the welded-on Inlet Collar resting on the top end of the Stand Pipe, and with the top O-ring seal (in red) disposed in-between. The Filler Tube is bolted to, and hangs from, the welded-on Inlet Collar at 4 positions circumferentially, using special bolts that have very thin heads. The middle O-ring seal (red) is disposed in-between the sidewall of the welded-on Inlet Collar and the Filler Tube.

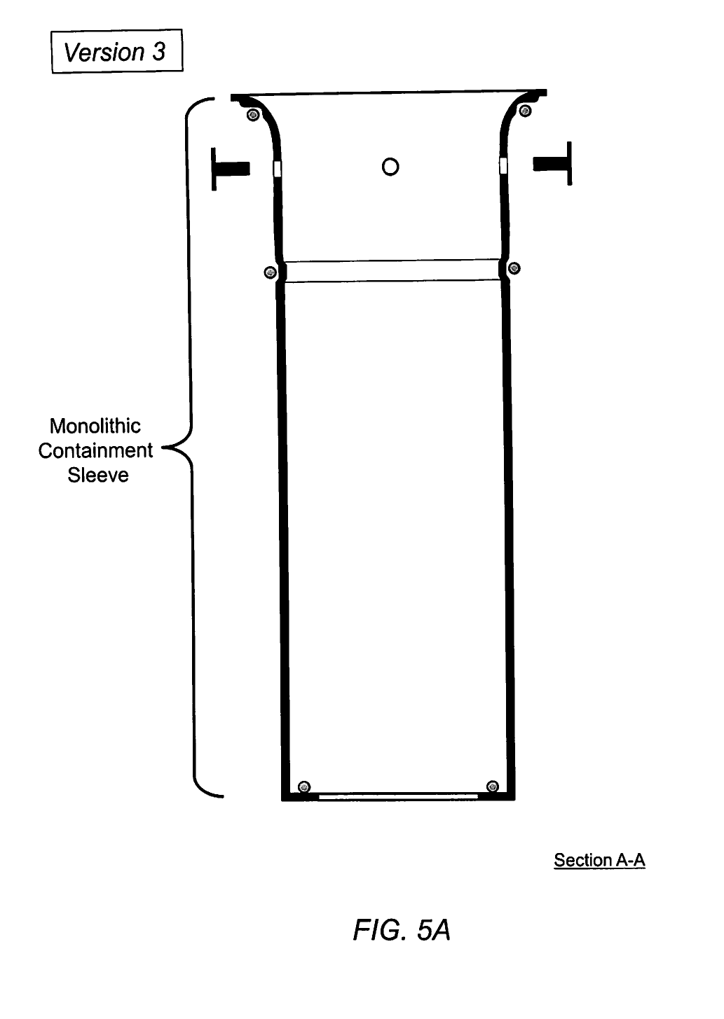

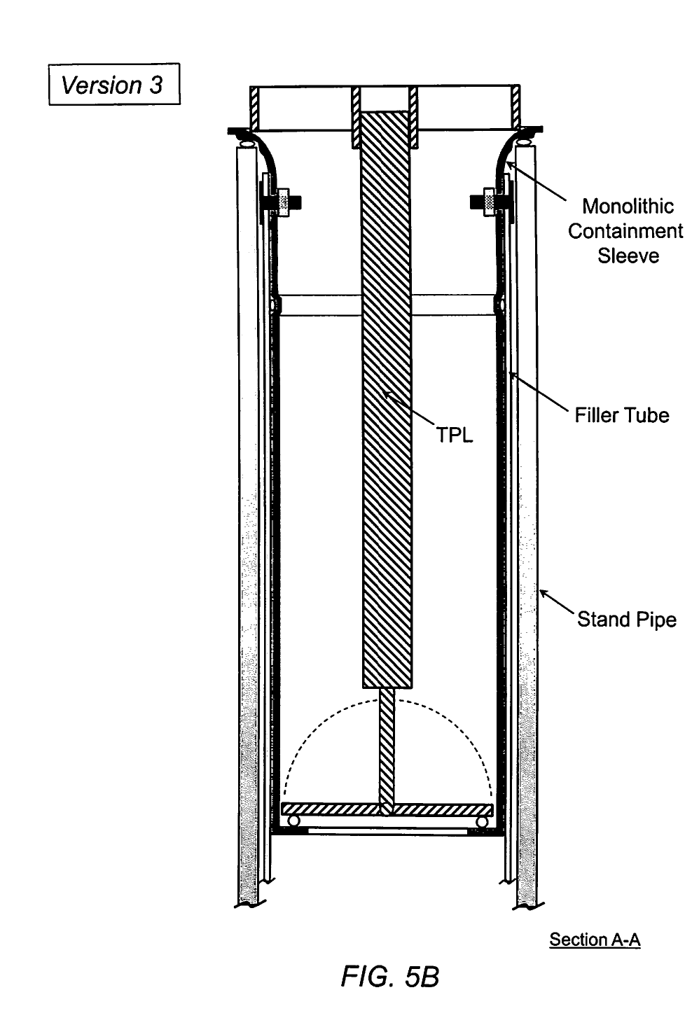

FIG. 5A shows a cross-section, elevation view of another example of a Drop-in Containment Sleeve (“Sleeve”), according to the present invention. In this embodiment (Version 3) the Sleeve comprises a single, monolithic (seamless) piece (as opposed to the design of FIG. 4A that comprises two parts that are welded together). The upper region of the Sleeve in FIG. 5A has a fluted/curved top flange contour (same as the contour of the Inlet Collar of FIG. 4A), with a circumferential flat for holding/seating the top O-ring seal. In other words, the contour of the Inlet Collar is incorporated into the design of the monolithic Sleeve in FIG. 5A. The Sleeve also comprises multiple bolt holes; and a dimpled, circumferential groove for holding the middle O-ring seal. Note that the design illustrated in FIG. 5A combines the dual functions of both: (1) the Inlet Collar, and (2) the sealing lip on the bottom flange, in an integrated, monolithic Containment Sleeve, which also eliminates the need to weld or join two separate parts together (as in FIG. 4A).

FIG. 5B shows the Sleeve of FIG. 5A, with a Transmix Prevention Lock (TPL) installed in the Sleeve. The TPL is in the closed (“activated”) configuration, with the pair of stopper plates released and folded down. The stopper plates make a tight seal with the bottom O-ring. The Sleeve can contain fuel that is stopped by the closed TPL. In this version (Version 3) the Containment Sleeve is installed inside of a Filler Tube, with the top flange of the Containment Sleeve resting on the top end of the Stand Pipe, and with the top O-ring seal (in pink) disposed in-between. The Filler Tube is bolted to, and hangs from, the Containment Sleeve at 4 positions circumferentially, using special bolts that have very thin heads. The middle O-ring seal (pink) is disposed in-between the sidewall of the Containment Sleeve and the Filler Tube.

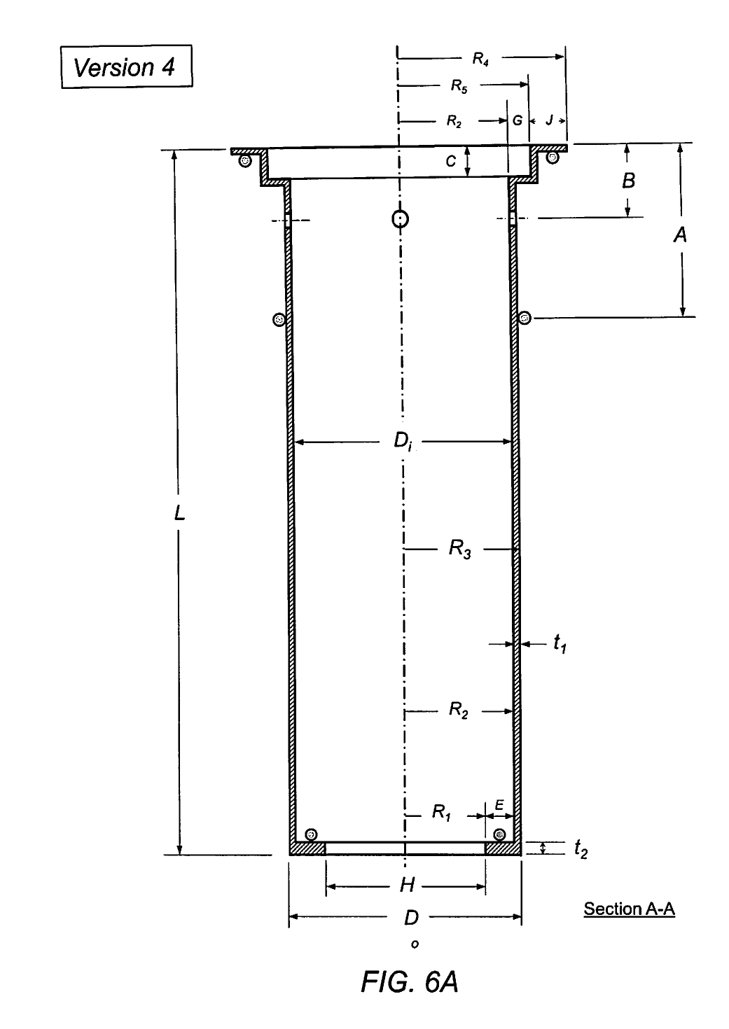

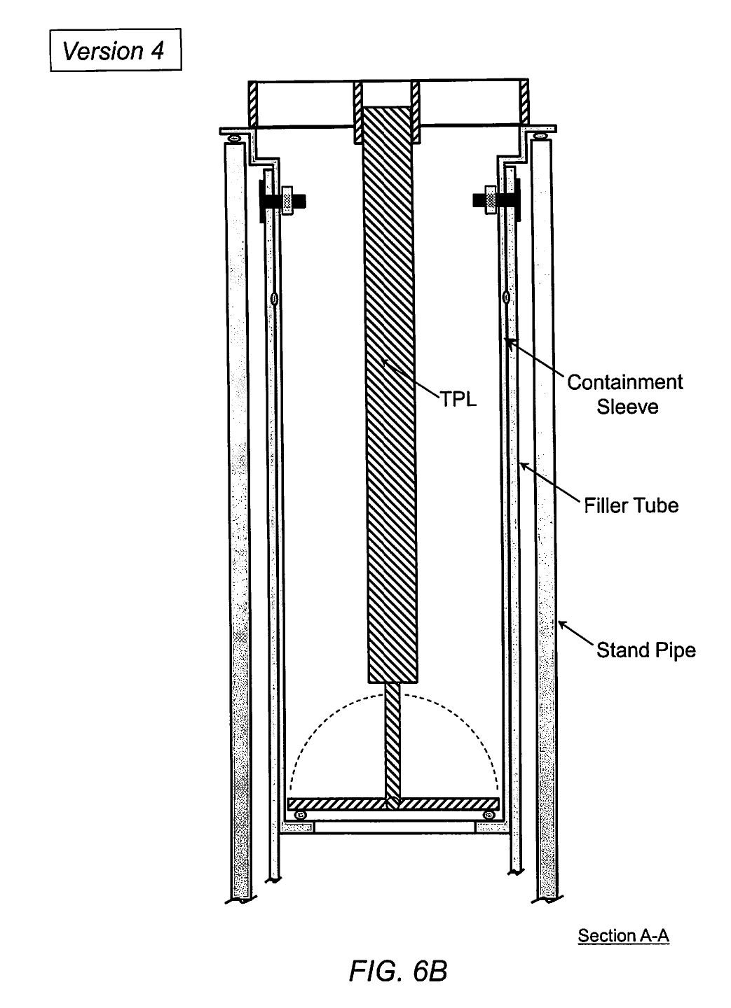

FIG. 6A shows a cross-section, elevation view of an example of a Drop-in Containment Sleeve (“Sleeve”), according to the present invention. The Sleeve comprises a long, cylindrical tube with an open central bore: an open top end; an open bottom end; a straight sidewall; 4 bolt holes through the sidewall, near the top end; a radially-outward step in the upper profile of the Sleeve; an outwardly-extending top flange; and an inwardly-extending bottom flange (sealing lip) for holding an O-ring seal. Additionally, a set of three (or more) O-ring seals can be provided with the Sleeve: a bottom O-ring, a middle O-ring, and a top O-ring. The O-rings can be made of an elastomeric material that is resistant to petroleum vapors. Optionally, the Sleeve can be fabricated with no (zero) holes for bolts (e.g., for custom installations where the holes are punched in the field to meet an existing configuration).

FIG. 6A also shows labeled dimensions of the Sleeve, which are the same dimensions and ranges as listed previously in FIG. 1B (with some exceptions, as listed below). The radially-outward step in the upper profile of the Sleeve is defined by the radial dimensions R₂ and G, and R₅; and by the axial length, C. The second inner radius, R₂, of the inner sidewall can range from 1-2″, with a nominal value of 1.76″, The radial width, G, can range from 0 to 0.5″, with a nominal value of 0.25″. The axial length, C, can range from 0 to 0.5″, with a nominal value of 0.25″. The radial width, J, of the top flange can range from 0.2 to 0.5″, with a nominal value of 0.3″. The fourth inner radius, R₅, of the upper step is related by the following, (R₅=R₂+G). The ratio, R₄/R₅>1.2. In other word, R₄ must be at least 20% greater than of R₅. Note, that, as illustrated in FIG. 6A, the thickness of the bottom flange, t₂, can be different (e.g., greater) than the wall thickness, t₁, of the sleeve's cylindrical tube. The tube's wall thickness, t₁, can range from 0.020-0.125″, with a nominal value of 0.050″. The bottom flange's thickness, t₂, can range from 0.020-0.25″, with a nominal value of 0.125″. The greater thickness of the bottom flange may be required to provide sufficient stiffness to properly support the bottom O-ring's sealing of the closed stopper plates; while allowing thinner metal to be used in the long cylindrical wall of the Sleeve. The greater thickness of the bottom flange (relative to the tube's wall thickness) can be used in any example or embodiment of the present invention (i.e., not just in FIG. 6A).

FIG. 6B shows the Sleeve of FIG. 6A, with a Transmix Prevention Lock (TPL) installed in the Sleeve. The TPL is in the closed (“activated”) configuration, with the pair of stopper plates released and folded down. The stopper plates make a tight seal with the bottom O-ring (in red). The Sleeve can contain fuel that is stopped by the closed TPL. In this version (Version 4) the Containment Sleeve is installed inside of a Filler Tube, with the top flange of the Containment Sleeve resting on the top end of the Stand Pipe, and with the top O-ring seal (in red) disposed in-between. The Filler Tube is bolted to, and hangs from, the Containment Sleeve at 4 positions circumferentially, using special bolts that have very thin heads. The middle O-ring seal (red) is disposed in-between the sidewall of the Containment Sleeve and the Filler Tube. The radially-outward step (i.e., jog) in the upper profile of the Sleeve helps to define and separate the Filler Tube from the Stand Pipe.

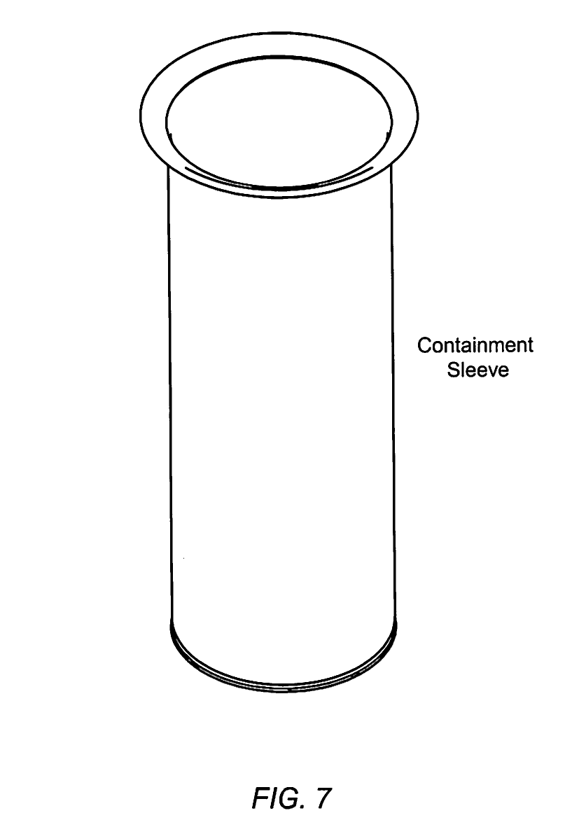

FIG. 7 shows one embodiment of a Drop-in Containment Sleeve (“Sleeve”), according to the present invention in an isometric view where the top flange and bottom flange are seamlessly connected to the open-ended hollow cylindrical tube with the bottom flange integrally formed by cold pressing/forming a rolled edge/hem that defines the sealing lip/surface for holding the bottom O-ring seal and the top flange integrally formed by cold pressing/forming a rolled edge/hem that defines the top flange's mating surfaces.

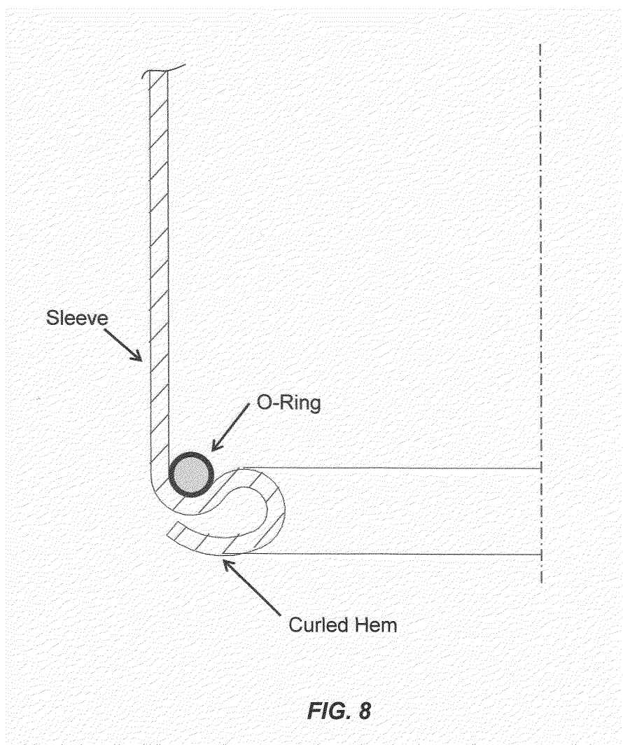

FIG. 8 shows a different embodiment of a curled/rolled edge or hem that forms the inwardly-facing bottom flange and sealing lip of the Containment Sleeve. In FIG. 8, the hem has been rolled so that it forms a circumferential “trough” that is sufficiently wide to hold and almost-capture the bottom O-ring seal, in a more secure way than as compared to the flat (horizontal) sealing lip surface of the previous examples.

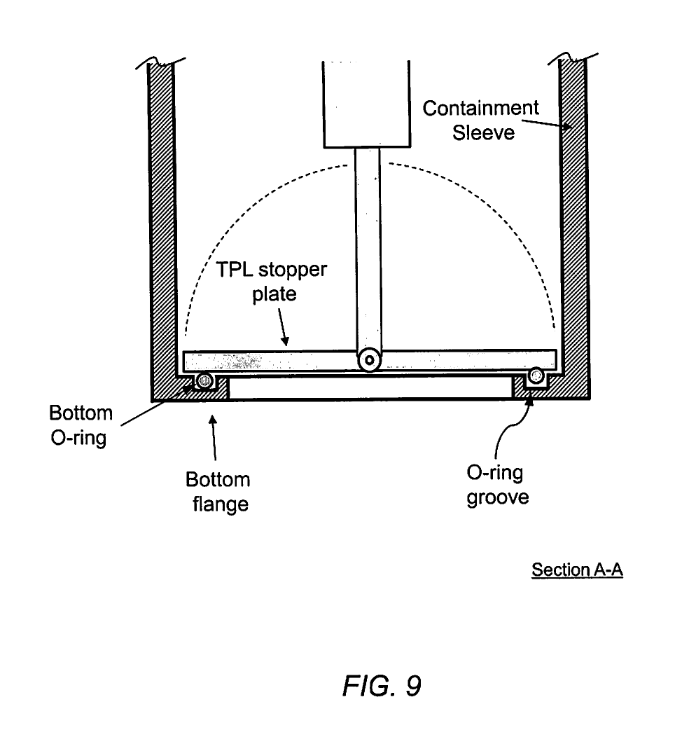

FIG. 9 shows a cross-section, elevation view of an example of an O-ring seal configuration. The bottom flange has a circumferential groove for holding and securing the bottom O-ring seal. The groove can have a square, rectangular (as illustrated), V-shaped, or semi-circular cross-sectional shape. The groove can have a re-entrant shape (not illustrated) that captures the O-ring.

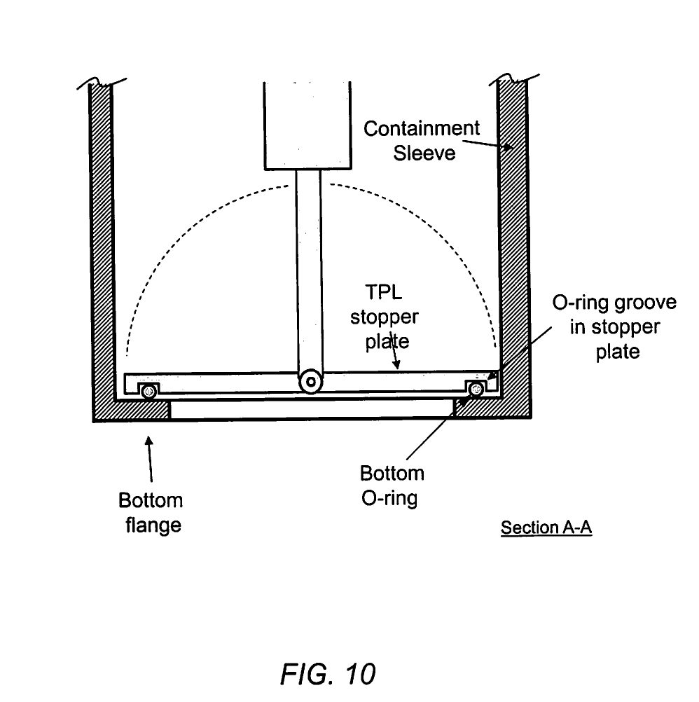

FIG. 10 shows a cross-section, elevation view of another example of an O-ring seal configuration. The TPL stopper plate(s) has a circumferential groove for holding and securing a segment of O-ring seal, The groove can have a square, rectangular (as illustrated), V-shaped, or semi-circular cross-sectional shape. The groove can have a re-entrant shape (not illustrated) that captures the O-ring.

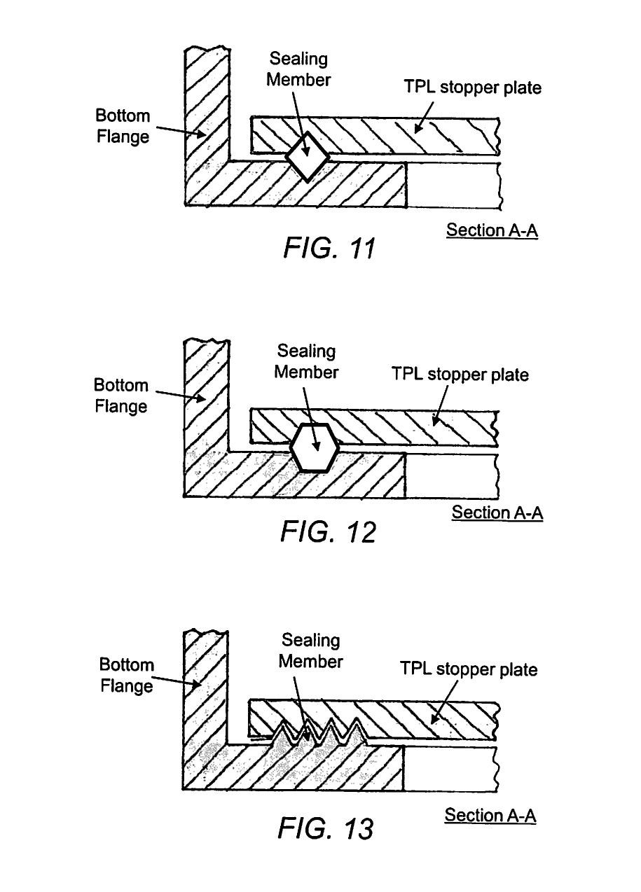

FIG. 11 shows a cross-section, elevation view of an example of an alternative sealing geometry for the bottom flange. The bottom flange has a V-shaped (triangular), upwardly-facing circumferential groove for holding the lower-half of a diamond-shaped sealing member. The diamond-shaped sealing member forms a complete circle (like an O-ring seal does), and it can be made of an elastomeric material (e.g., Buna-N), or it can be made of metal (which can be a soft metal, like annealed copper or indium), or graphite (carbon). The TPL stopper plate above has a matching, V-shaped, downwardly-facing circumferential groove for receiving the upper half of the diamond-shaped sealing member. Alternatively, the cross-sectional geometry of the sealing member can be selected from a diamond, a hexagon, a polygon, a circle, an ellipse and a triangle.

FIG. 12 shows a cross-section, elevation view of another example of an alternative sealing geometry for the bottom flange. The bottom flange has an upwardly-facing circumferential groove for holding the lower-half of a hexagon-shaped sealing member. The hexagon-shaped sealing member forms a complete circle (like an O-ring seal does), and it can be made of an elastomeric material (e.g., Buna-N), or it can be made of metal (which can he a soft metal, like annealed copper or indium), or graphite (carbon). The TPL stopper plate above has a matching, downwardly-facing circumferential groove shaped for receiving the upper half of the hexagon-shaped sealing member.

FIG. 13 shows a cross-section, elevation view of another example of an alternative sealing configuration for the bottom flange. The bottom flange has a series of multiple, circumferential, upwardly-protruding knife-edges, which fits into a mating set of circumferential grooves in the TPL stopper plate. The combination of the multiple extended surfaces provides an even-greater increased resistance to fluid flow, without having to use a separate O-ring seal. The set of multiple, circumferential, upwardly-protruding knife-edges (or complementary grooves) can be fabricated as either (1) a series of independent (not connected) knife-edges (or grooves), or (2) as a single, continuous, spiral-shaped knife-edge (or groove).

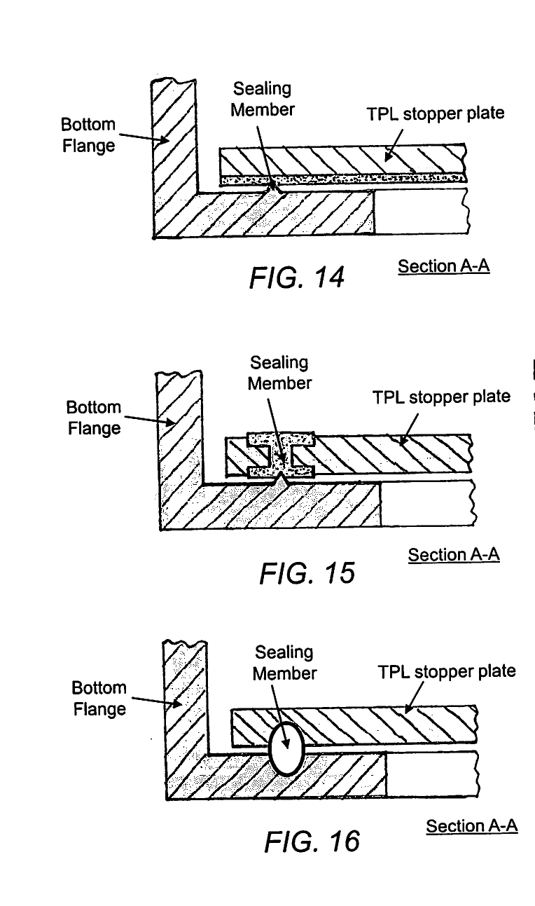

FIG. 14 shows a cross-section, elevation view of another example of an alternative sealing geometry for the bottom flange. The bottom flange has a circumferential, upwardly-protruding knife-edge. The lower surface (underside) of the TPL stopper plate(s) has a resilient/elastomeric surface (e.g., rubber, silicone) bonded to metal (or plastic) stopper plate. The knife-edge protrusion of the bottom flange pushes into (or cuts into) the resilient surface, forming a liquid-tight seal.

FIG. 15 shows a cross-section, elevation view of another example of an alternative sealing geometry for the bottom flange. The bottom flange has a circumferential, upwardly-protruding knife-edge. The “I-beam” shaped insert in the stopper plate(s) is made of a resilient/elastomeric surface (e.g., rubber, silicone). The knife-edge protrusion of the bottom flange pushes into (or cuts into) the resilient surface, forming a liquid-tight seal. The “I-beam” shape of the resilient material allows it to ‘lock’ into the TPL stopper plate without requiring the use of adhesives.

FIG. 16 shows a cross-section, elevation view of another example of an alternative sealing geometry for the bottom flange. The bottom flange has an upwardly-facing circumferential groove for holding the lower-half of an oval-shaped sealing member. The oval -shaped sealing member forms a complete circle (like an O-ring seal does), and it can be made of an elastomeric material (e.g., Buna-N), or it can be made of metal (which can be a soft metal, like annealed copper or indium), or graphite (carbon). The TPL stopper plate above has a matching, downwardly-facing circumferential groove shaped for receiving the upper half of the oval-shaped sealing member.

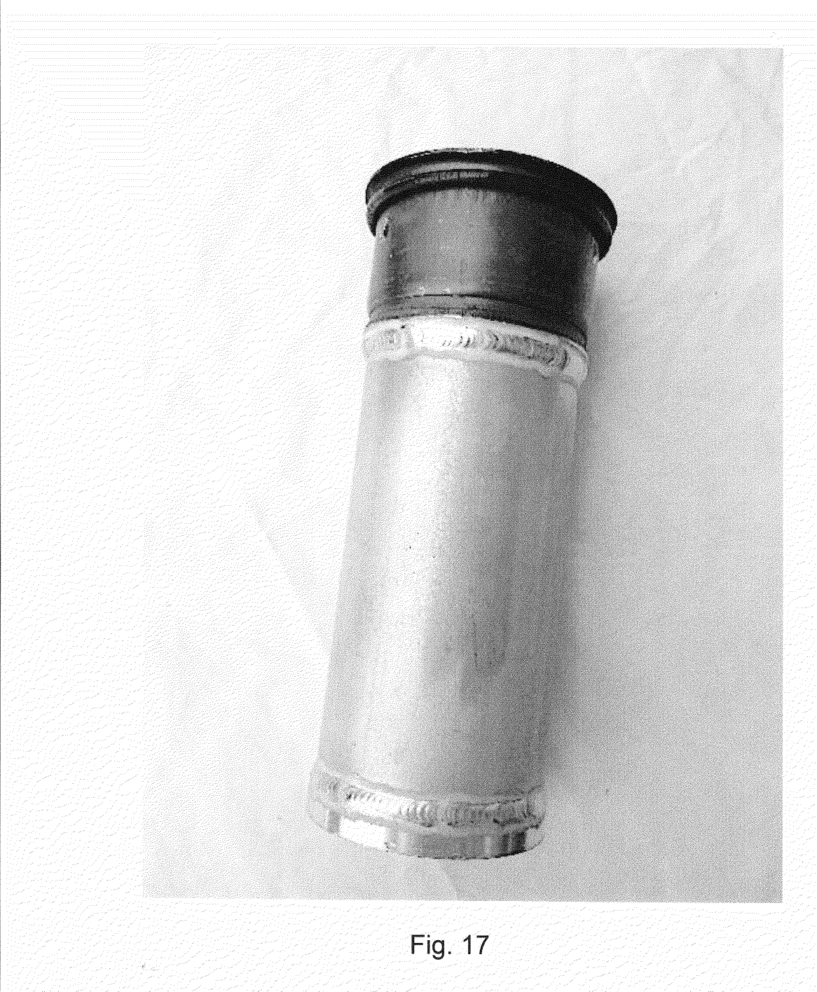

FIG. 17 shows a black and white photograph of a prototype Containment Sleeve made according to FIG. 4A (Version 2). For this particular prototype, a separate bottom flange part (not drawn) was welded on to a straight section of tubing to make the straight lower-half of the Sleeve.

Although the invention has been described with reference to one or more particular embodiments, this description is not meant to be construed in a limiting sense. Various modifications of the disclosed embodiments as well as alternative embodiments of the invention will become apparent to persons skilled in the art. It is therefore contemplated that the appended claims will cover any such modification or embodiments that fall within the scope of the invention. The entire disclosures of all references, applications, patents and publications cited above are hereby incorporated by reference.

What is claimed is:

1. A drop-in containment sleeve, comprising:
an open-ended hollow cylindrical tube, said open-ended hollow cylindrical tube comprising an open central bore; an open top end; an open bottom end; and a sidewall, an outwardly-extending top flange; and
an inwardly-extending bottom flange configured for allowing a liquid-tight seal to be made between the inwardly-extending bottom flange and a Transmix Prevention Lock type flow control device.

2. The drop-in containment sleeve according to claim 1 wherein an O-ring is disposed on said inwardly-extending bottom flange to allow said liquid-tight seal.

3. The drop-in containment sleeve according to claim 1 wherein said drop-in containment sleeve is disposed within a standpipe of a storage vessel.

4. The drop-in containment sleeve according to claim 3 wherein at least one O-ring is disposed between the sidewall of said drop-in containment sleeve and said standpipe.

5. The drop-in containment sleeve according to claim 3 wherein at least one O-ring is disposed between the outwardly-extending top flange of said drop-in containment sleeve and said standpipe.

6. The drop-in containment sleeve according to claim 1 wherein said outwardly-extending top flange comprises a commercially-available inlet collar, said inlet collar welded onto said open-ended hollow cylindrical tube.

7. The drop-in containment sleeve according to claim 6 wherein at least one bolt hole is disposed in the side wall of said inlet collar for providing structural support between said drop-in containment sleeve and a standpipe.

8. The drop-in containment sleeve according to claim 1 wherein said inwardly-extending bottom flange is welded to said open-ended hollow cylindrical tube.

9. The drop-in containment sleeve of claim 1 wherein said open central bore has an inner diameter, D₁, between 2 and 5 inches, an outer diameter, D₀, between 2 and 5 inches, said sidewall has a thickness of between 0.020 and 0.125 inches, said outwardly-extending top flange has an outer radius of between 1.5 and 3 inches, said inward-extending bottom flanges has an inner radius of between 1 and 2 inches, and said drop-in containment sleeve has a length of between 8 and 12 inches.

10. The drop-in containment sleeve of claim 1 wherein said drop-in containment sleeve comprises a material selected from the group consisting of a metal alloy and a fiber-reinforced plastic.

11. The drop-in containment sleeve of claim 10 wherein said metal alloy is selected from the group consisting of aluminum, steel and brass,

12. The drop-in containment sleeve of claim 1 wherein said inwardly-extending bottom flange comprises a rolled edge that provides a sealing surface for holding an O-ring.

13. The drop-in containment sleeve of claim 1 wherein said inwardly-extending bottom flange comprises a circumferential groove for holding an O-ring.

14. The drop-in containment sleeve of claim 13 wherein said circumferential groove comprises a cross-sectional geometrical shape selected from the group consisting of square, rectangular, V-shapes, hexagonal and semi-circular.

15. The drop-in containment sleeve of claim 12 wherein said inwardly-extending bottom flange comprises a circumferential sealing member with a cross-sectional geometrical shape selected from a diamond, a hexagon, a polygon, a circle, an ellipse and a triangle, said circumferential sealing member mating with a circumferential groove on emplaced Transmix Prevention Lock stopper plates to provide a seal to prevent liquid flow.

16. The drop-in containment sleeve of claim 1 further comprising an inlet collar attached externally to said sidewall of said drop-in containment sleeve.

17. A flow protection system, comprising:
a Transmix Prevention Lock type flow control device emplaced in a drop-in containment sleeve, said drop-in containment sleeve comprising an open-ended hollow cylindrical tube, said open-ended hollow cylindrical tube comprising an open central bore; an open top end; an open bottom end; and a sidewall, an outwardly-extending top flange; and an inwardly-extending bottom flange configured for allowing a liquid-tight seal to be made between the inwardly-extending bottom flange and a Transmix Prevention Lock type flow control device.

18. The flow protection system of claim 17 wherein said flow protection system is disposed within a standpipe connected to a petroleum storage vessel.

19. The flow protection system of claim 17 wherein said Transmix Prevention Lock type flow control device comprises stopper plates in an activated position and said inwardly-extending bottom flange comprises a circumferential O-ring disposed to contact said stopper plates to provide a liquid-tight seal between said stopper plates and said inwardly-extending bottom flange.

20. A drop-in containment sleeve, comprising:
an open-ended hollow cylindrical tube, said open-ended hollow cylindrical tube comprising an open central bore; an open top end; an open bottom end; and a sidewall, an outwardly-extending top flange seamlessly connected to said open top end; and an inwardly-extending bottom flange seamlessly connected to said open bottom end, said inwardly-extending bottom flange configured for allowing a liquid-tight seal to be made between the inwardly-extending bottom flange and a Transmix Prevention Lock type flow control device.
